(19) United States
(12) Patent Application Publication
(10) Pub. No.: US 2024/0216873 A1
(43) Pub. Date: Jul. 4, 2024

(54) POLYMER FOR HOLLOW FIBER MEMBRANE FOR ORGANIC SOLVENT NANOFILTRATION AND METHOD FOR MANUFACTURING THE SAME

(71) Applicant: GWANGJU INSTITUTE OF SCIENCE AND TECHNOLOGY, Gwangju (KR)

(72) Inventors: Hee Chul CHOI, Gwangju (KR); Eun Mok YANG, Gwangju (KR)

(21) Appl. No.: 18/397,353

(22) Filed: Dec. 27, 2023

(30) Foreign Application Priority Data
Jan. 2, 2023 (KR) 10-2023-0000187

(51) Int. Cl. B01D 71/64; B01D 61/02; B01D 67/00; B01D 69/08; C08J 3/24; C08J 9/224; C08J 9/28

(52) U.S. Cl. CPC B01D 71/64; B01D 61/027; B01D 67/0006; B01D 69/08; C08J 3/24; C08J 9/224; C08J 9/28; B01D 2323/30; C08J 2201/0504; C08J 2379/08

(57) ABSTRACT

Embodiments are related to a hollow fiber membrane for organic solvent nanofiltration comprising an intermolecularly cross-linked polymer material represented by Formula 1, comprising a polymer for an intermolecularly cross-linked hollow fiber membrane for organic solvent nanofiltration represented by Formula 1, and the hollow fiber membrane for organic solvent nanofiltration made of the polymers has the effect of having stability and improved permeance for organic solvents.

### CROSS REFERENCE TO RELATED APPLICATION

The present application claims priority to Korean Patent Application No. 10-2023-0000187, filed Jan. 2, 2023, the entire contents of which is incorporated herein for all purposes by this reference.

### BACKGROUND OF THE INVENTION

### Field of the Invention

The disclosure relates to a polymer for a hollow fiber membrane for organic solvent nanofiltration and a method for manufacturing the same, and to a hollow fiber membrane for organic solvent nanofiltration using a cross-linked polymer.

### Description of the Related Art

In general, a separation process required for the chemical industry and pharmaceutical industry includes processes such as distillation, crystallization, adsorption and extraction, which are generally carried out by using an organic solvent. Thus, there is a continuously increasing need for an organic solvent separation membrane. However, most separation membranes developed or commercialized to date have been produced for water treatment or gas separation. Therefore, such separation membranes have a limitation in retaining a stable chemical structure under the environment requiring exposure for various organic solvents. As a result, although there has been an industrial need for an organic solvent separation membrane and the scale thereof is not small, development of organic solvent separation membranes has been insufficient.

As an organic solvent nanofiltration membrane, a composite membrane having a polyamide thin film formed on a polyimide support, a polybenzimidazole membrane polymerized from tetramine and dicarboxylic acid, a polyetheretherketone membrane, and the like have been known. Particularly, in the case of an organic solvent nanofiltration membrane, its pore size is important but the interaction between a solvent or solute and the membrane affects the performance of the separation membrane. Thus, there is an imminent need for developing a material having excellent stability against organic solvents. In addition, conventional polyimide, cross-linked polybenzimidazole, and polyetheretherketone membranes manufactured in the form of asymmetric membranes are used in limited organic solvents and temperature ranges because it is often difficult to obtain excellent permeance even if they are stable in organic solvents. Therefore, various types of separation membrane materials and shapes and improved separation performance are required.

Recently, membrane-based separation technology has been considered efficient as an alternative separation process due to its advantages such as low energy consumption, low carbon footprint, and low secondary pollutant emissions. Among the membrane-based separation processes, organic solvent nanofiltration (OSN) can separate molecules in the range of approximately 200 to 2,000 g/mol from organic solutions. The organic solvent nanofiltration can be applied to organic solution concentration, solvent exchange, and purification, and it has great potential in the separation process of various chemical industries. Various companies and researchers are actively researching polymer of intrinsic microporosity (PIM)-based membranes. Despite improving the properties of membranes by studying dye adsorption properties, swelling properties, and filtration properties, research on the development of organic solvent nanofiltration membranes to date has mainly focused on flat membrane types compared to hollow fiber configurations, and commercial organic Solvent nanofiltration membranes are limited to the flat membrane type. In particular, little research has been reported in the literature on the development of ultra-thin film composite (TFC) type membranes, and ultra-thin hollow fibers based on microporous polymers have not been manufactured for the organic solvent nanofiltration. Therefore, there is a need for research on a microporous polymer-based separation membrane for organic solvent nanofiltration that has stability and high efficiency in organic solvent permeance.

### SUMMARY

An object of the disclosure to solve the above-mentioned problems is to provide a polymer for a hollow fiber membrane for organic solvent nanofiltration which can achieve high performance and improved organic solvent stability by introducing intermolecular cross-linking between polymer chains in order to improve organic solvent stability without compromising the pore properties of microporous polymers (PIMs)-based membranes, and a method for manufacturing the same.

In order to achieve the above object, an embodiment of the disclosure may comprise an intermolecular cross-linked polymer represented by Formula (1) below:

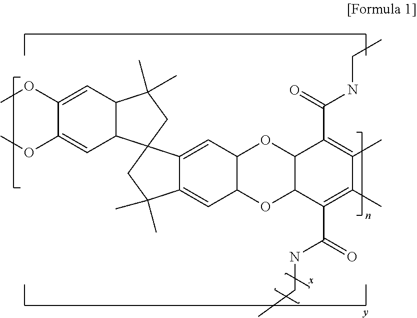

(where the x is an integer from 2 to 12, the n is an integer from 2 to 7000, and the y is an integer from 2 to 7000).

In one embodiment of the disclosure, the intermolecular cross-linked polymer may be formed by cross-linking a cross-linking agent between polymers represented by Formula (2) below:

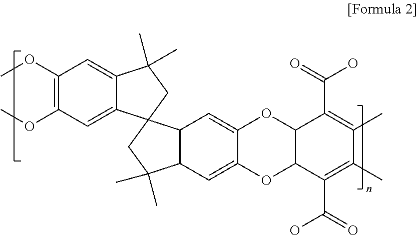

(where the n is an integer from 2 to 70000).

In one embodiment of the disclosure, the cross-linkingagent may include an alkyldiamine-based cross-linking agent.

In one embodiment of the disclosure, the alkyldiamine-based cross-linking agent may include hexadiamine.

In order to achieve the above technical object, another embodiment of the disclosure provides a method for manufacturing a polymer for a hollow fiber membrane for organic solvent nanofiltration.

In one embodiment of the disclosure, the method comprises the steps of preparing a microporous polymer (PIM-1); generating a carboxylic acid-functionalized microporous polymer (PIM-COOH) by functionalizing a functional group of the microporous polymer (PIM-1); producing a carbonyl chloride-functionalized microporous polymer (PIM-COCl) by adding thionyl chloride to the carboxylic acid-functionalized microporous polymer (PIM-COOH); and preparing an intermolecular cross-linked polymer by adding an alkyldiamine-based cross-linking agent to the carbonyl chloride-functionalized microporous polymer (PIM-COCl).

In one embodiment of the disclosure, the functional group of the microporous polymer (PIM-1) may include methyl, ether, nitrile, carboxyl, amine, carbonyl chloride, amidoxime, tetrazole, or thioamide.

In one embodiment of the disclosure, the step of preparing the intermolecular cross-linked polymer may include the steps of coating the carbonyl chloride-functionalized microporous polymer (PIM-COCl) on a support by performing a dip coating process; and preparing the intermolecular cross-linked polymer by adding the alkyldiamine-based cross-linking agent to the support coated with the carbonyl chloride-functionalized microporous polymer (PIM-COCl).

In one embodiment of the disclosure, the intermolecular cross-linked polymer may include a polymer represented by Formula (1) below:

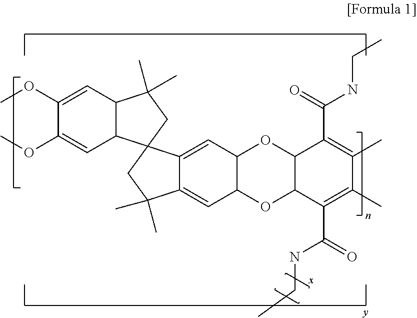

(where the x is an integer from 2 to 12, the n is an integer from 2 to 7000, the y is an integer from 2 to 7000).

In order to achieve the above technical object, another embodiment of the disclosure provides a hollow fiber membrane for organic solvent nanofiltration.

In one embodiment of the disclosure, the above described hollow fiber membrane for organic solvent nanofiltration may comprise a polymer for a hollow fiber membrane for organic solvent nanofiltration.

### BRIEF DESCRIPTION OF THE DRAWINGS

FIG. 1 is a schematic diagram simply illustrating a process of manufacturing a cross-linked microporous-based ultra-thin hollow fiber (XPIM TFC HF) membrane according to an embodiment of the disclosure.

FIGS. 2(a)-2(c) are diagrams of an analysis of the spectra of microporous polymer (PIM-1), carboxylic acid functionalized microporous polymer (PIM-COOH), and carbonyl chloride functionalized microporous polymer (PIM-COCl) according to an embodiment of the disclosure.

FIG. 3 is a diagram of top and cross-sectional microscopic images of a cross-linked microporous-based ultra-thin hollow fiber (XPIM TFC HF) according to an embodiment of the disclosure.

FIGS. 4(a)-4(d) are graphs illustrating the analysis of a cross-linked microporous-based ultra-thin hollow fiber (XPIM TFC HF) separation membrane and the analysis of organic solvent stability according to an embodiment of the disclosure.

FIGS. 5(a)-5(f) are diagrams of a core-level X-ray photoelectron spectroscopy (XPS) spectrum, according to an embodiment of the disclosure, where (a, d) are images of a cross-linked polyimide hollow fiber (XPI HF) support, (b, g) are images of a carbonyl chloride-functionalized microporous polymer-based cross-linked polyimide hollow fiber (PIM-COCl TFC HF) membrane, and (c, h) are images of a cross-linked microporous-based ultrathin hollow fiber (XPIM TFC HF) for N 1S and Cl 2p.

FIGS. 6(a)-6(d) are diagrams illustrating a filtration performance of a cross-linked microporous-based ultrathin hollow fiber (XPIM TFC HF) membrane, where (a) is a graph of pure ethanol permeance, (b) is a graph of organic solvent nanofiltration performance, (c) is a graph of organic solvent permeance of a 1.5-cross-linked microporous-based ultrathin (1.5-XPIM TFC) membrane, and (d) is a graph of the molecular weight cutoff (MWCO) of the 1.5-cross-linked microporous-based ultrathin (1.5-XPIM TFC) membrane.

FIGS. 7(a)-7(b) are diagrams illustrating organic solvent stability according to an embodiment of the disclosure, where (a) is a graph of changes in rejection performance of 1.5-PIM-1 and 1.5-cross-linked microporous-based ultrathin hollow fiber (1.5-XPIM TFC HF) membranes after immersion in organic solvent for 3 days, and (b) is a graph of a long-term performance of the 1.5-cross-linked microporous-based ultra-thin hollow fiber (1.5-XPIM TFC HF) membrane after immersion in organic solvent for 7 days.

FIG. 8 is a graph illustrating an analysis of pure ethanol permeance and molecular weight cutoff of a microporous polymer (PIMs)-based organic solvent nanofiltration membrane and hollow fiber organic solvent nanofiltration membrane according to an embodiment of the disclosure.

### DETAILED DESCRIPTION

Hereinafter, the disclosure will be explained with reference to the accompanying drawings. The disclosure, however, may be modified in various different ways, and should not be construed as limited to the embodiments set forth herein. Also, in order to clearly explain the disclosure, portions that are not related to the disclosure are omitted, and like reference numerals are used to refer to like elements throughout the specification.

In the whole specification, it will be understood that when an element is referred to as being “connected (joined, contacted, or coupled)” to another element, it can be “directly connected” to the other element or it can be “indirectly connected” to the other element with other elements being interposed therebetween. In addition, it will be understood that when a component is referred to as “comprising or including” any component, it does not exclude other components, but can further comprise or include the other components unless otherwise specified.

The terminology used in the specification is for the purpose of describing particular embodiments only and is not intended to limit the disclosure. The singular forms are intended to include the plural forms as well, unless context clearly indicates otherwise. It will be further understood that the terms “comprises/includes” or “comprising/including” when used in this specification, specify the presence of stated features, integers, steps, operations, elements, components, or combinations thereof, but do not preclude the presence or addition of one or more other features, integers, steps, operations, elements, components, and combinations thereof.

Hereinafter, the disclosure will be described in detail with reference to the accompanying drawings.

In one embodiment according to the disclosure, it may be characterized by comprising an intermolecular cross-linked polymer represented by the following Formula (1):

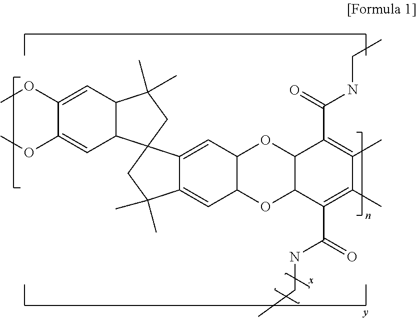

Where the x is an integer from 2 to 12, the n is an integer from 2 to 7000, and the y is an integer from 2 to 7000.

The x may represent the number of alkyl groups of the cross-linking agent when cross-linking the intermolecular cross-linked polymer represented by Formula 1.

For example, the x may be an integer between 2 and 12.

The n may be a symbol representing the repetitive structure of the units constituting the intermolecular cross-linked polymer represented by Formula 1.

For example, the n may be an integer between 2 and 7000.

The y may be a symbol representing the repetitive structure of the polymer including the cross-linking agent when cross-linking the intermolecular cross-linked polymer represented by Formula 1.

For example, the y may be an integer between 2 and 7000.

The cross-linking means connecting or bonding between chains if there is a long polymer chain.

The intermolecular cross-linked polymer may be formed by cross-linking a cross-linking agent between the polymers represented by the following Formula (2):

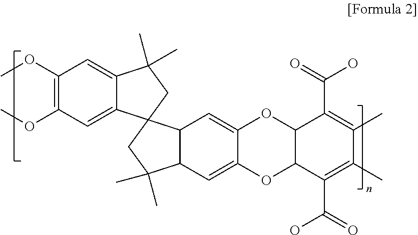

Where the n is an integer from 2 to 7000.

The polymer represented by Formula 2 may be referred to as carbonyl chloride functionalized microporous polymer (PIM-COCl), but is not limited thereto.

The carbonyl chloride functionalized microporous polymer (PIM-COCl) may be a product in which some of the functional groups of the microporous polymer (PIM-1) are replaced with chlorine and oxygen.

The cross-linking agent may include an alkyldiamine-based cross-linking agent.

The cross-linking agent may refer to an additive that can improve heat resistance, cohesion, etc. by adding the additive to the adhesive to form a polymer network structure.

The alkyldiamine-based cross-linking agent may include hexadiamine.

Hexadiamine may be referred to as hexamethylenediamine, but is not limited thereto.

The hexadiamine is an organic compound with the molecular formula C6H12N¬¬2, with two amine groups attached to a hexamethylene chain. The hexadiamine is a colorless solid with a strong amine group odor, similar to piperidine.

In order to achieve the above-described technical object, a method for manufacturing a polymer for a hollow fiber membrane for organic solvent nanofiltration, which is an embodiment of the disclosure, is provided.

The method for manufacturing a polymer for a hollow fiber membrane for organic solvent nanofiltration of the disclosure comprises the steps of preparing a microporous polymer (PIM-1); generating a carboxylic acid-functionalized microporous polymer (PIM-COOH) by functionalizing a functional group of the microporous polymer (PIM-1); producing a carbonyl chloride-functionalized microporous polymer (PIM-COCl) by adding thionyl chloride to the carboxylic acid-functionalized microporous polymer (PIM-COOH); and preparing an intermolecular cross-linked polymer by adding an alkyldiamine-based cross-linking agent to the carbonyl chloride-functionalized microporous polymer (PIM-COCl).

The first step may be a step for preparing the microporous polymer (PIM-1).

The microporous polymer (PIM-1) may include a continuous network of interconnected intermolecular pores with a width of less than 2 nm.

The microporous polymers are classified as porous organic polymers and can create porosity in rigid, twisted macromolecular chains that do not pack efficiently in a solid state.

Additionally, the microporous polymer may be composed of a fused ring sequence interrupted by a spiro compound.

In this case, due to the fused ring structure, the microporous polymer cannot rotate freely along a polymer backbone, thereby preventing the shape of the polymer components from rearrangement and ensuring that the highly distorted shape is fixed during synthesis.

The second step may be a step for functionalizing the functional group of the microporous polymer (PIM-1) to produce the carboxylic acid-functionalized microporous polymer (PIM-COOH).

The carboxylic acid-functionalized microporous polymer can be produced by performing an acid hydrolysis method on the microporous polymer.

The acid hydrolysis method may be a hydrolysis method in which a positive acid is used to catalyze the cleavage of a chemical bond through a nucleophilic substitution reaction by adding water.

For example, there is a reaction that breaks down cellulose or starch into glucose.

The functionalization may be a process of adding new functions, features, abilities, or properties to a material by changing its surface chemistry.

Additionally, the functionalization is performed by attaching molecules or nanoparticles to the surface of the material. In some cases, the functionalization has a chemical bond, but in some cases, the functionalization may be performed simply through adsorption.

In this case, the process of functionalizing the functional group of the microporous polymer is performed by chemical bonding, and a reason why functionalization is necessary is because the functional group of the microporous polymer is not suitable for the cross-linking reaction with the alkyldiamine-based cross-linking agent to be processed later, due to its high chemical stability.

The functional group of the microporous polymer (PIM-1) may include methyl, ether, nitrile, carboxyl, amine, carbonyl chloride, amidoxime, tetrazole, or thioamide.

The third step may be a step for producing a carbonyl chloride functionalized microporous polymer (PIM-COCl) by adding thionyl chloride to the carboxylic acid-functionalized microporous polymer (PIM-COOH).

The thionyl chloride is an inorganic compound whose chemical formula is SOCl2. It is a volatile, colorless liquid with an unpleasant pungent odor and can act as a source of chloride ions.

The fourth step may be a step for preparing an intermolecular cross-linked polymer by adding the alkyldiamine-based cross-linking agent to the carbonyl chloride-functionalized microporous polymer (PIM-COCl).

The fourth step of preparing the intermolecular cross-linked polymer includes the steps of coating the carbonyl chloride-functionalized microporous polymer (PIM-COCl) on a support by performing a dip coating process; and preparing the intermolecular cross-linked polymer by adding the alkyldiamine-based cross-linking agent to the support coated with the carbonyl chloride-functionalized microporous polymer (PIM-COCl).

The support may be prepared with a cross-linked polyimide hollow fiber (XPI HF) through a laboratory-scale dry jet wet spinning process.

The dry jet wet spinning process is a method for discharging into an air or gas atmosphere and then entering a coagulating liquid.

For example, when spinning a polymer with a relatively high degree of polymerization with a dopant dissolved in high concentration, the spinning temperature inevitably increases. However, if the wet spinning method is adopted, the temperature of the coagulating liquid also increases, making it difficult to obtain fibers with a dense structure. On the contrary, the dry jet wet spinning process can solve the above-mentioned problems.

The dip coating process is one of the simple processes that can prepare a thin film on a substrate and is a technology used in many manufacturing industries.

For example, the dip coating process is used in various manufacturing industries such as the medical field and wire coating.

The intermolecular cross-linked polymer may include a polymer represented by the following Formula (1):

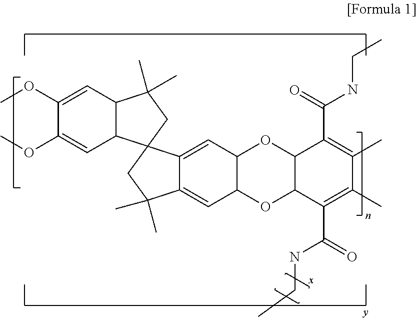

(where the x is an integer from 2 to 12, the n is an integer from 2 to 7000, and the y is an integer from 2 to 7000).

Another embodiment of the disclosure will be described.

In order to achieve the above-described technical object, an embodiment of the disclosure provides a hollow fiber membrane for organic solvent nanofiltration comprising a polymer for a hollow fiber membrane for organic solvent nanofiltration.

The nanofiltration is a separation process that uses membranes driven by pressure. Also it is known as low pressure reverse osmosis. A nanomembrane can usually trap particles of 1 to 10 nm. The characteristic of the nanofiltration membrane is that it reject more multivalent ions than monovalent ions. The rejection characteristics of ions vary depending on the membrane, and in a general nanofiltration membrane, the rejection rate of multivalent ions is 95%, and the rejection rate of monovalent ions is about 20%. The advantage of the nanofiltration membrane over a reverse osmosis membrane, which is another membrane technology that removes ions, is that the nanofiltration membrane can handle large flow rates. This can reduce operating costs because the nanofiltration membrane operates at relatively low pressure.

Among the nanofiltration membranes, a hollow fiber membrane is widely used worldwide for industrial water, industrial wastewater, and drinking water applications. It is especially suitable for large-capacity municipal drinking water and wastewater treatment plants.

The hollow fiber membrane is designed to maximize surface area and have very high packing densities. Therefore, regardless of the flow pattern, the hollow fiber membrane can be considered a compact and cost-effective solution because it filters large volumes of liquid with high permeance using minimal space and energy.

The hollow fiber membrane for organic solvent nanofiltration according to an embodiment of the disclosure filters a large volume of liquid with high permeance like the hollow fiber membrane described above, so it can be compact and cost-effective.

In addition, the hollow fiber membrane for organic solvent nanofiltration has been prepared by introducing intermolecular cross-linking between polymer chains to improve organic solvent stability without damaging the pore characteristics of the microporous polymer membrane. Also, the hollow fiber membrane for organic solvent nanofiltration not only has superior filtration performance compared to existing technologies, but also has improved organic solvent stability, so it is expected to be commercialized as an organic solvent nanofiltration membrane.

Not only is this excellent, but it also has improved organic solvent stability, so it can be predicted that it can be commercialized as an organic solvent nanofiltration membrane.

Hereinafter, a method for manufacturing a polymer for a hollow fiber membrane for organic solvent nanofiltration of the disclosure will be described in detail with reference to the drawings.

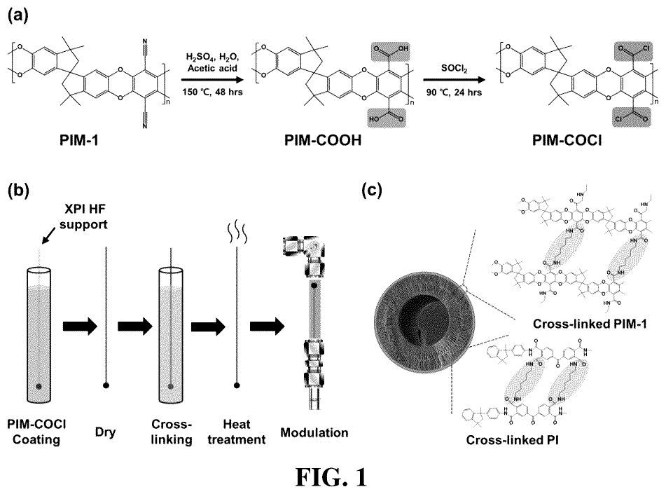

FIG. 1 is a schematic diagram illustrating a method for manufacturing a polymer for a hollow fiber membrane for organic solvent nanofiltration according to an embodiment of the disclosure.

### Example 1: Preparation of a Polymer for a Hollow Fiber Membrane for Organic Solvent Nanofiltration

### 1. Preparation of Microporous Polymer (PIM-1)

In (a) of FIG. 1, a microporous polymer (PIM-1) was prepared by polycondensation reaction of tetrafluoroterephthalonitrile and tetramethylspirobisindane.

The tetrafluoroterephthalonitrile was purified by vacuum sublimation at 140° C.

The tetramethylspirobisindane was recrystallized with hot methanol and dichloromethane.

Then, after mixing the tetrafluoroterephthalonitrile (3.00 g, 15.0 mmol) and tetramethylspirobisindane (5.11 g, 15.0 mmol) in dry dimethylformaldehyde (100 ml) until monomers were completely dissolved, potassium carbonate (5.18 g, 37.5 mmol) was added to the monomer solution.

Then, a solution obtained by adding potassium carbonate to the monomer solution was immersed in a preheated oil bath.

For example, the immersion process was carried out for 72 hours under a nitrogen atmosphere at 65° C.

After the reaction was completed, the solution was sufficiently cooled to room temperature, and then 200 ml of distilled water was poured into the solution for quenching and polymer precipitation.

In the process of pouring distilled water, the precipitated polymer can be filtered and unreacted salts can be removed by adding more distilled water.

Then, the filtered polymer was dissolved in chloroform (200 ml) and then re-infiltrated with methanol.

The filtered polymer was filtered and dried in a vacuum oven at 70° C. for 3 days to prepare an intrinsic microporous polymer, PIM-1 (Mn=25,450, PDI=1.66).

### 2. Preparation of a Carboxylic Acid-Functionalized Microporous Polymer (PIM-COOH)

Referring to (a) of FIG. 1, the process of producing a carboxylic acid-functionalized microporous polymer (PIM-COOH) was performed by the acid hydrolysis method described above for the intrinsic microporous polymer (PIM-1).

2.00 g of the microporous polymer (PIM-1) powder was added to a pre-solution mixed with 90 ml of distilled water, 90 ml of sulfuric acid, and 30 ml of glacial acetic acid.

Then, the solution was strongly stirred and refluxed at 150° C. for 48 hours.

After the functionalization was complete, the solution was sufficiently cooled to room temperature.

Then, 2000 ml of distilled water was poured into the solution sufficiently cooled to room temperature to neutralize the solution, and then the powder was filtered.

The filtered powder was boiled in distilled water containing a few drops of an acidic solution for 12 hours to remove residual reagents.

The acidic solution may include sulfuric acid, but is not limited thereto.

Then, the functionalized polymer was filtered, rinsed with sufficient amounts of distilled water and methanol, and dried in a vacuum oven at 70° C. to prepare the carboxylic acid-functionalized microporous polymer (PIM-COOH).

### 3.Preparation of a Carbonyl Chloride-Functionalized Microporous Polymer (PIM-COCl)

Referring to (a) of FIG. 1, the carbonyl chloride-functionalized microporous polymer (PIM-COCl) is produced by first adding 1.50 g of the carboxylic acid-functionalized microporous polymer (PIM-COOH) powder to 50 ml of thionyl chloride (SOCl2) and strongly stirring the mixture while refluxing at 90° C. for 24 hours.

The thionyl chloride was removed by vacuum distillation, and the remaining polymer was dissolved in 200 ml of chloroform and redeposited on nucleic acid.

The redeposited polymer was filtered and dried in a vacuum oven at 25° C. for 3 days to prepare the carbonyl chloride-functionalized microporous polymer (PIM-COCl).

### 4.Preparation of Cross-Linked Polyimide-Based Ultrathin Hollow Fiber (XPI TFC HF) Support.

In FIG. 1, (b) is a schematic diagram illustrating a process of preparing a cross-linked microporous-based ultrathin hollow fiber (XPIM TFC HF) support by dip coating a polyimide hollow fiber-based hollow fiber (PI-HF) support.

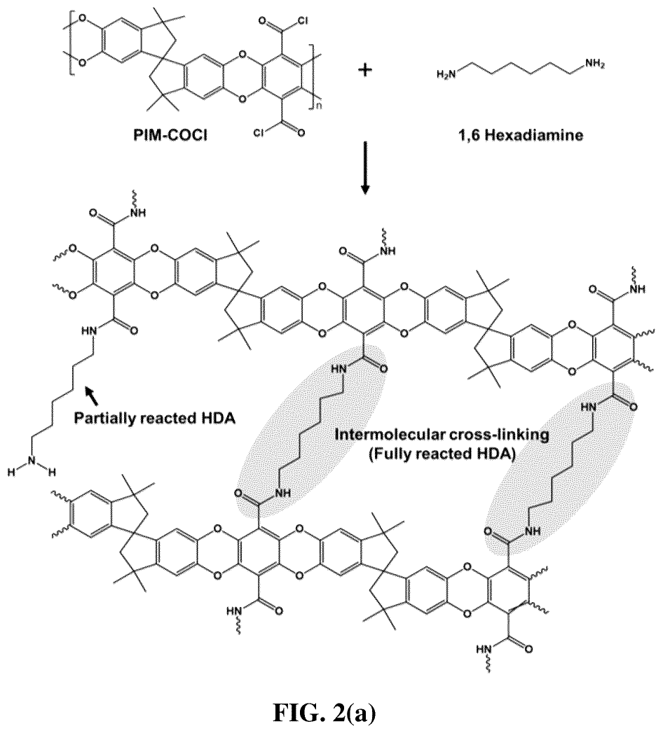

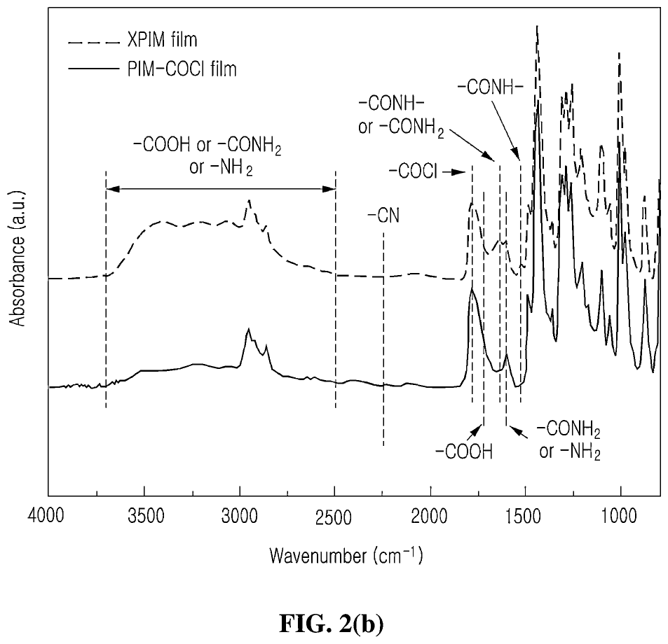

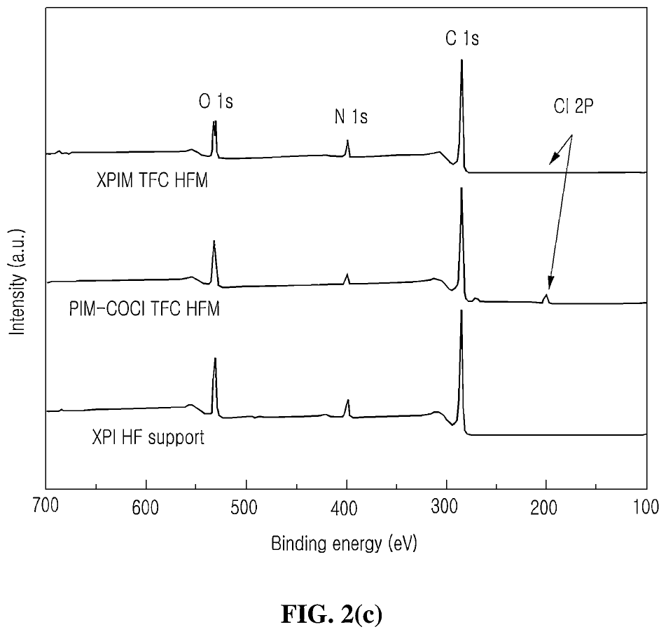

In (b) of FIG. 2, the polyimide hollow fiber (PI HF) support was prepared with the cross-linked microporous-based ultra-thin hollow fiber (XPIM TFC HF) support.

Additionally, the polyimide hollow fiber (PI HF) support was prepared through a laboratory-scale dry jet wet spinning process.

First, polyimide (PI), methylpyrrolidone (NMP), and polyethylene glycol 400 (PEG400) were stirred vigorously as a dope solution until it became transparent and homogeneous.

The dope solution was degassed at 50° C. overnight before spinning.

Then, the stirred solution was transferred to a syringe pump and sufficiently cooled to room temperature.

In this case, distilled water and the dope solution were supplied to the inner and outer channels of the spinerette, respectively.

Then, the distilled water and dope solution met in an air-gap area and entered a coagulation tank.

Then, as-spun fibers were collected by a winding drum.

Then, the as-spun fiber was soaked in distilled water for 2 days to remove residual reagents.

In this case, the residual reagent may include methylpyrrolidone and ethylene glypol 400.

Then, the as-spun fiberswere subjected to solvent exchange three times using isopropyl alcohol (IPA) to remove residual water.

The solvent exchange may be performed for 1 hour each time.

The as-spun fibers were cross-linked by immersing them in a 10% by weight of hexadiamine/isopropyl alcohol solution for 15 hours at room temperature.

Then, the as-spun fibers were washed three times for 3 hours with the isopropyl alcohol and distilled water.

Finally, the cross-linked polyimide-based ultrathin hollow fiber (XPI TFC HF) support was prepared by treating the as-spun fibers with a 50% by weight of glycerol aqueous solution for 2 days and then drying them in an air atmosphere.

### 5.Preparation of a Cross-Linked Microporous-Based Ultrathin Hollow Fiber (XPIM TFC HF) Membranes

In FIG. 1, (c) is a schematic diagram illustrating the composition of the cross-linked microporous-based ultra-thin hollow fiber (XPIM TFC HF) membrane.

Referring to (b) of FIG. 1, the cross-linked polyimide-based ultrathin hollow fiber (XPI TFC HF) membrane was prepared by dip-coating directly on the outer surface of the cross-linked polyimide hollow fiber (XPI HF) support.

First, one end of the cross-linked hollow polyimide fiber (XPI HF) support was sealed with epoxy to prevent the coating solution from flowing into a lumen.

Then, the cross-linked hollow polyimide fiber (XPI HF) support was rinsed with ethanol and dried in a vacuum oven for 2 hours.

In FIG. 2, (a) is a schematic diagram illustrating the cross-linked polymer of the disclosure, and in detail, it illustrates a proposed chemical reaction between the carbonyl chloride-functionalized microporous polymer (PIM-COCl) and hexadiamine (HDA) to create intermolecular cross-linking.

In FIG. 2, (b) illustrates using a free-standing dense film based on the carbonyl chloride-functionalized microporous polymer (PIM-COCl) and cross-linked microporosity, in order to confirm the cross-linking reaction between the carbonyl chloride-functionalized microporous polymer (PIM-COCl) of (a) of FIG. 1 and the hexadiamine.

It can be confirmed that the peak at the intensity of 1644 cm-1 increased after the cross-linking reaction by the HDA, and a new peak appeared at 1525 cm-1 corresponding to the C═O stretching and N—H bending vibration of the amide.

However, it can be confirmed that the peak at 1780 cm-1 of the carbonyl chloride (—COCl) group still exists due to the unreacted carbonyl chloride (—COCl) group in the cross-linked microporous-based free-standing dense film. This is because the packing density of the dense film is high, making it difficult for a cross-linking reaction to occur deep inside the film due to geometric and dimensional constraints.

Therefore, typically the detection depth of attenuated total reflection infrared spectroscopy (ATR-FTIR) mode exceeds 0.5 to 1 μm thickness, so that it can be confirmed that the intensity of the carbonyl chloride group (—COCl) in attenuated total reflection infrared spectroscopy (ATR-FTIR) is higher than that of the amide group (—CONH).

After the carbonyl chloride-functionalized microporous polymer (PIM-COCl) coating and cross-linking reaction, the cross-linked polyimide hollow fiber (XPI HF) support, carbonyl chloride-functionalized microporous polymer (PIM-COCl), and cross-linked microporous-based ultrathin hollow fiber (XPIM TFC HF) membrane were analyzed using X-ray photoelectron spectroscopy (XPS).

In FIG. 2, (c) is a graph showing the X-ray photoelectron spectroscopy survey spectrum and elemental composition.

Referring to (c) of FIG. 2, it can be confirmed that the cross-linked hollow polyimide fiber (XPI HF) support mainly showed peaks of oxygen, nitrogen, and carbon.

However, after coating the carbonyl chloride-functionalized microporous polymer (PIM-COCl) on the cross-linked polyimide hollow fiber (XPI HF) support, a new Cl 2p peak appeared in the X-ray photoelectron spectroscopy spectrum of the carbonyl chloride-functionalized microporous polymer-based ultrathin hollow fiber (PIM-COCl TFC HF) membrane, due to chlorine in the carbonyl chloride-functionalized microporous polymer (PIM-COCl).

Theoretical prediction for the atomic composition of the carbonyl chloride-functionalized microporous polymer (PIM-COCl) does not include the nitrogen element.

However, the experimental elemental composition of the carbonyl chloride-functionalized microporous polymer (PIM-COCl) includes the nitrogen element due to the unstable reaction and reverse reaction during the functionalization of the microporous polymer (PIM-1). Accordingly, the X-ray photoelectron spectroscopy spectrum of the carbonyl chloride-functionalized microporous polymer-based ultrathin hollow fiber membrane shows an N is peak.

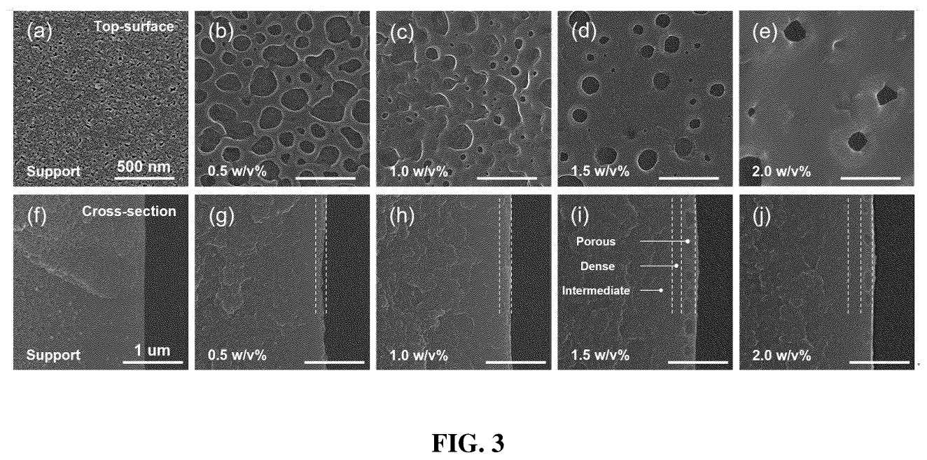

FIG. 3 shows a photograph of the microstructure of the top surface and cross-section of the cross-linked microporous-based ultrathin hollow fiber (XPIM TFC HF) membrane according to a method for preparing a polymer for a hollow fiber membrane for organic solvent nanofiltration of the disclosure, which is observed with a field emission-scanning electron microscope (FE-SEM) after dip coating the carbonyl chloride-functionalized microporous polymer/chloroform solution at n weight/volume %.

In order to prepare the cross-linked microporous-based ultrathin hollow fiber membrane, a process of immersing the cross-linked polyimide hollow fiber support in n weight/volume % of the carbonyl chloride-functionalized microporous polymer/chloroform solution and then removing the support was performed.

The n value specifically includes 0.5, 1.0, 1.5, and 2.0, and the immersion and removal process was performed by varying the n value.

First, the cross-linked microporous-based ultrathin hollow fiber was prepared by varying the concentration of the carbonyl chloride-functionalized microporous polymer/chloroform solution.

First, the carbonyl chloride-functionalized microporous polymer/chloroform solution was prepared at a concentration of 0.5 weight/volume %, immersed vertically for 5 seconds, and then removed.

Then, the carbonyl chloride-functionalized microporous polymer/cross-linked polyimide composite membrane was dried in a low humidity oven at room temperature for 30 minutes and then dried under vacuum for 2 hours.

Then, the composite membrane was cross-linked by immersing it in a 0.25% by weight of hexadiamine/hexane solution for 1 hour.

Then, the cross-linked microporous-based ultrathin hollow fiber membrane was prepared by thoroughly rinsing the composite membrane with hexane and drying it in an oven at 75° C. for 10 minutes.

The cross-linked microporous-based ultrathin hollow fiber membrane may be named x-cross-linked microporous-based ultrathin hollow fiber membrane. The x may refer to the concentration of the carbonyl chloride-functionalized microporous polymer in the coating solution.

Second, the cross-linked microporous-based ultrathin hollow fiber membrane was vertically immersed in 1.0 weight/volume % of the carbonyl chloride-functionalized microporous polymer/chloroform solution for 5 seconds and then removed.

Other preparation methods are the same as those for preparing the cross-linked microporous-based ultrathin hollow fiber.

Third, the cross-linked microporous-based ultrathin hollow fiber membrane was vertically immersed in 1.5 weight/volume % of the carbonyl chloride-functionalized microporous polymer/chloroform solution for 5 seconds and then removed.

Other preparation methods are the same as those for preparing the cross-linked microporous-based ultrathin hollow fiber.

Fourth, the cross-linked microporous-based ultrathin hollow fiber membrane was vertically immersed in 2.0 weight/volume % of the carbonyl chloride-functionalized microporous polymer/chloroform solution for 5 seconds and then removed.

Other preparation methods are the same as those for preparing the cross-linked microporous-based ultrathin hollow fiber.

In FIG. 3, (a) and (f) are photographs of the microstructure of the top surface and cross-section of the cross-linked polyimide hollow fiber membrane of the disclosure, respectively, observed with a field emission scanning electron microscope.

In FIG. 3, (a) to (e) are photographs showing that after the cross-linked microporous-based active layer is formed by dip-coating and cross-linking, the surface pores of the cross-linked polyimide hollow fiber support are completely covered by the cross-linked microporous-based active layer, which are observed with a field emission scanning electron microscope.

In FIG. 3, (b) and (g) are photographs showing the microstructure of the top surface and cross-section of the cross-linked microporous-based ultrathin hollow fiber membrane of the disclosure, respectively, when the carbonyl chloride-functionalized microporous polymer/chloroform solution was dip coated at 0.5 weight/volume %, which were observed with a field emission scanning electron microscope.

Referring to (b) to (e) of FIG. 3, it can be confirmed that the cross-linked microporous-based active layer of the cross-linked microporous-based ultrathin hollow fiber membrane (0.5% by weight/volume % to 2.0% by weight) has open pores and a crater pattern in the microstructure.

In FIG. 3, (c) and (h) are photographs showing the microstructure of the top surface and cross-section of the cross-linked microporous-based ultrathin hollow fiber membrane of the disclosure, respectively, when the carbonyl chloride-functionalized microporous polymer/chloroform solution was dip coated at 1.0 weight/volume %, which were observed with a field emission scanning electron microscope.

In FIG. 3, (d) and (i) are photographs showing the microstructure of the top surface and cross-section of the cross-linked microporous-based ultrathin hollow fiber membrane of the disclosure, respectively, when the carbonyl chloride-functionalized microporous polymer/chloroform solution was dip coated at 1.5 weight/volume %, which were observed with a field emission scanning electron microscope.

In FIG. 3, (e) and (j) are photographs showing the microstructure of the top surface and cross-section of the cross-linked microporous-based ultrathin hollow fiber membrane of the disclosure, respectively, when the carbonyl chloride-functionalized microporous polymer/chloroform solution was dip coated at 2.0 weight/volume %, which were observed with a field emission scanning electron microscope.

In FIG. 3, (b) to (e) show that the top microstructure of the cross-linked microporous base layer of the cross-linked microporous-based ultrathin hollow fiber membrane shows open pores and crater patterns, and show that as the concentration of the carbonyl chloride-functionalized microporous polymer coating solution increases, the number of open pores and craters decreases.

In addition, as the viscosity increases, solvent evaporation of the polymer coating solution slows down, so it can be confirmed that as the concentration of the polymer coating solution increases, the cross-linked microporous-based active layer with fewer open pores and craters is formed.

It can be confirmed that as the concentration of the carbonyl chloride-functionalized microporous polymer coating solution increases, the thickness of the cross-linked microporous-based active layer on the outer surface of the cross-linked polyimide support increases by about 150 nm to 400 nm.

### Experimental Example 1: Analysis and Organic Solvent Stability Test on the Cross-Linked Microporous-Based Ultra-Thin Hollow Fiber (XPIM TFC HF) Membrane

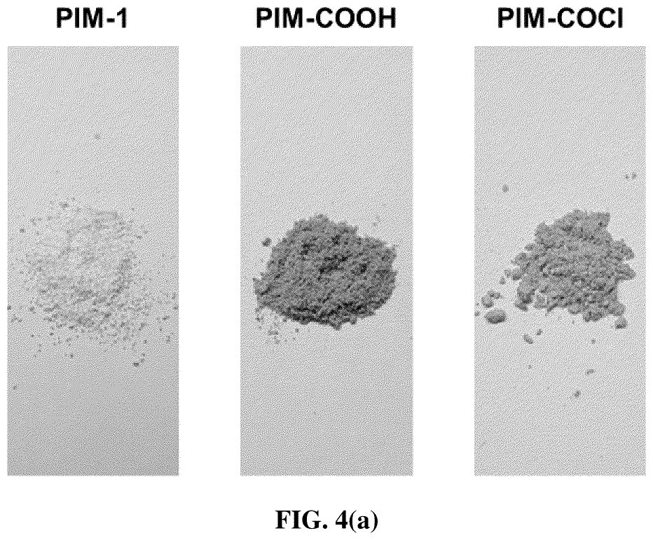

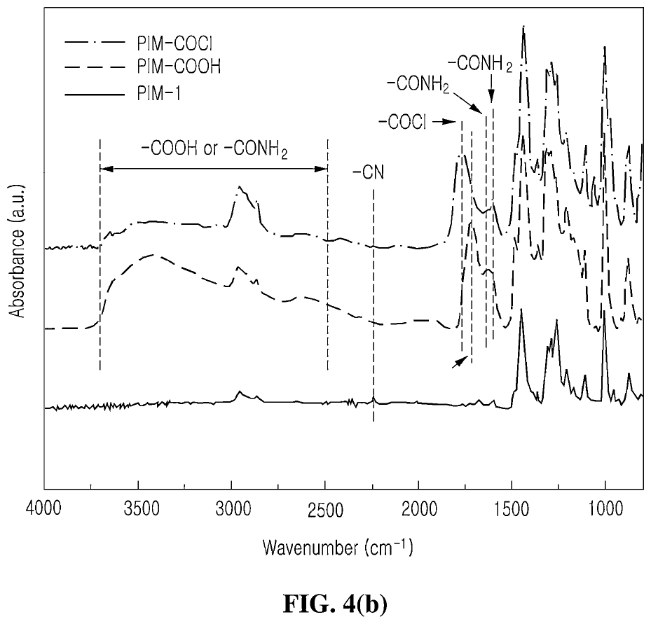

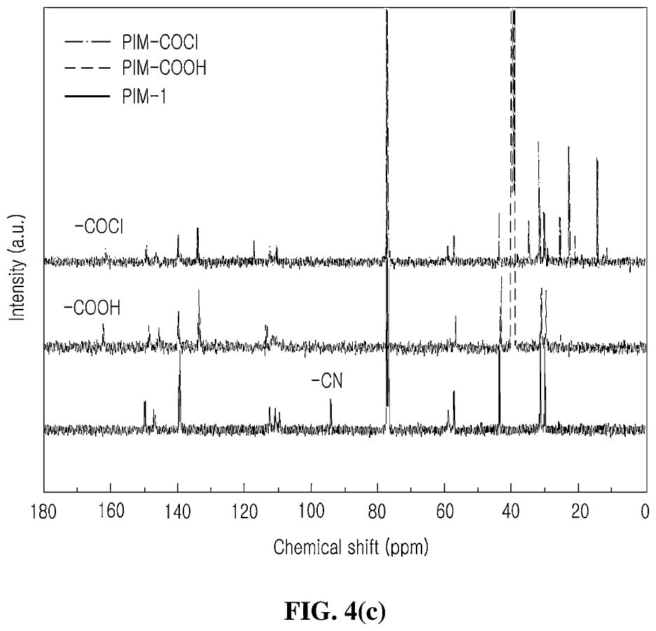

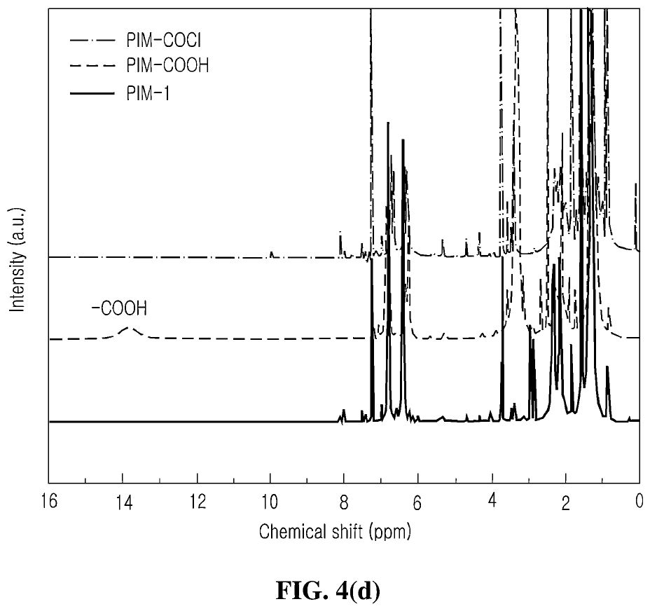

In FIG. 4, (a) shows that the microporous polymer (PIM-1), carboxylic acid-functionalized microporous polymer (PIM-COOH), and carbonyl chloride-functionalized microporous polymer (PIM-COCl) are expressed as fluorescent yellow, brown, and orange powders, respectively.

In order to analyze the cross-linked microporous-based ultrathin hollow fiber membrane using the cross-linked polymer of the disclosure and test its stability in organic solvents, a dense film of free-standing polymer (PIM-1, PIM-COCl, XPIM) was prepared and used.

In this case, the free-standing cross-linked microporous-based dense film was prepared by the same cross-linking method as the cross-linked microporous-based ultrathin hollow fiber membrane described above.

In FIG. 4, (b) is an image showing an attenuated total reflection infrared spectroscopy (ATR-FTIR) spectrum, (c) is an image showing a carbon nuclear magnetic resonance (13C NMR) spectrum, and (d) is an image showing a hydrogen nuclear magnetic resonance (1H NMR) spectrum.

First, in FIG. 4, (b) shows that the characteristic peak of —CN stretching vibration at 2240 cm-1 after acid hydrolysis can be converted to the characteristic peak of carboxylic acid at 1715 cm-1 and 2400 to 3400 cm-1, which mainly correspond to C═O and O—H stretching vibrations.

Next, in (c) of FIG. 4, the carbon nuclear magnetic resonance spectrum of the carboxylic acid-functionalized microporous polymer, wherein the chemical shift of the carbonyl amine group (—CONH2) was 162.0 ppm, was found to be 161.6 ppm, which appeared at a higher field than the carbon nuclear magnetic resonance signals of the carboxyl group 0 (—COOH) and carbonyl amine group (—CONH2¬). The reason may be that the carbonyl carbon is less shielded because the chloride group (—Cl) is less electronegative than the hydroxy group (—OH) and amine group (—NH2).

Next, in FIG. 4, (d) showed that in the hydrogen nuclear magnetic resonance spectrum of the carboxylic acid-functionalized microporous polymer, broad peaks appeared at 13 to 14 ppm and 7 to 8 ppm corresponding to carboxyl group (—COOH) and carbonyl amine group (—CONH2). This may be because the carboxyl group (—COOH) was converted to the carbonyl chloride group (—COCl) and thionyl chloride (SOCl2) had low solubility in deuterated chloroform (CDCl3¬), so there was unreacted carboxyl group (—COOH).

Therefore, as a result of analysis with attenuated total reflection infrared spectroscopy (ATR-FTIR) spectrum, carbon nuclear magnetic resonance (13C NMR) spectrum, and hydrogen nuclear magnetic resonance (1H NMR) spectrum, it can be confirmed that the carbonyl chloride-functionalized microporous polymer (PIM-COCl) functioned successfully for the preparation of microporous-based ultrathin hollow fiber (XPIM TFC HF) membrane crosslinked with the microporous polymer (PIM-1).

### Experimental Example 2: Core-Level X-Ray Photoelectron Spectroscopy (XPS) Spectrum Analysis Experiment

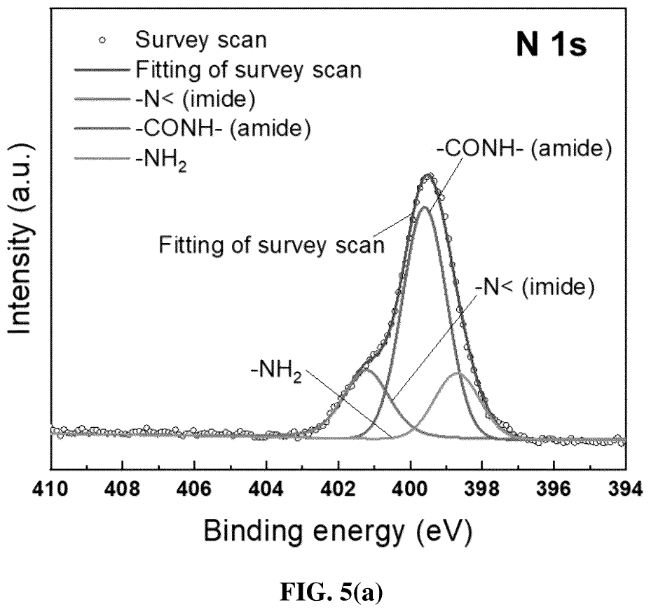

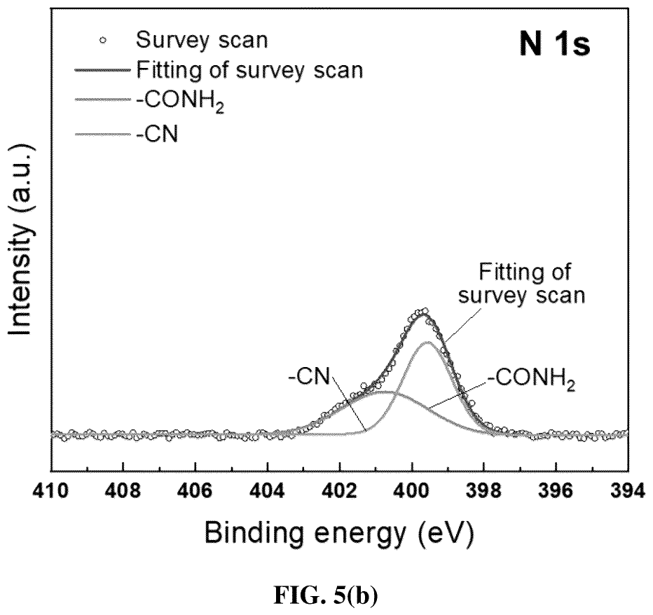

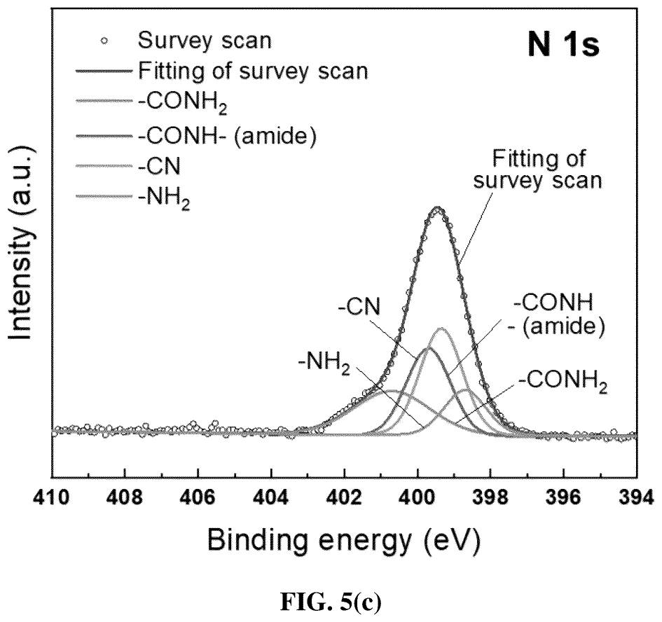

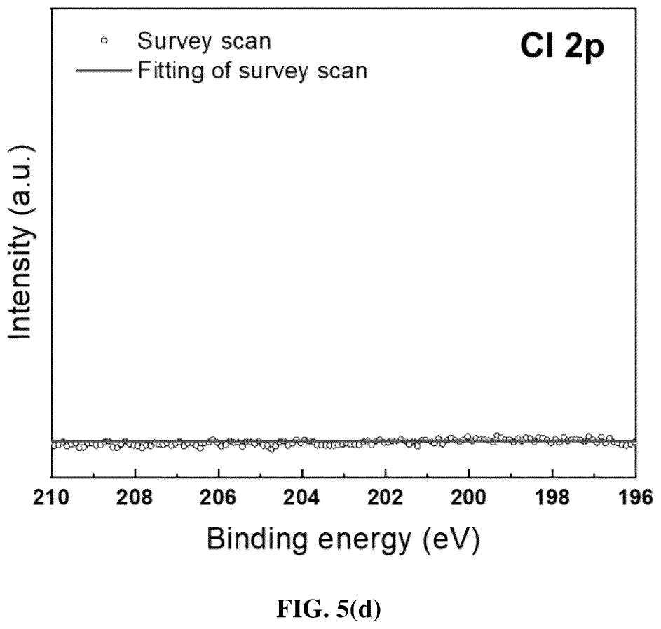

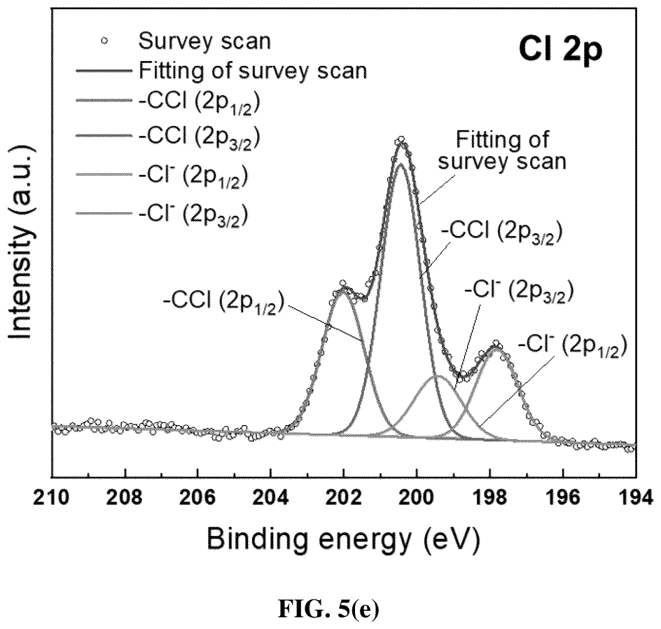

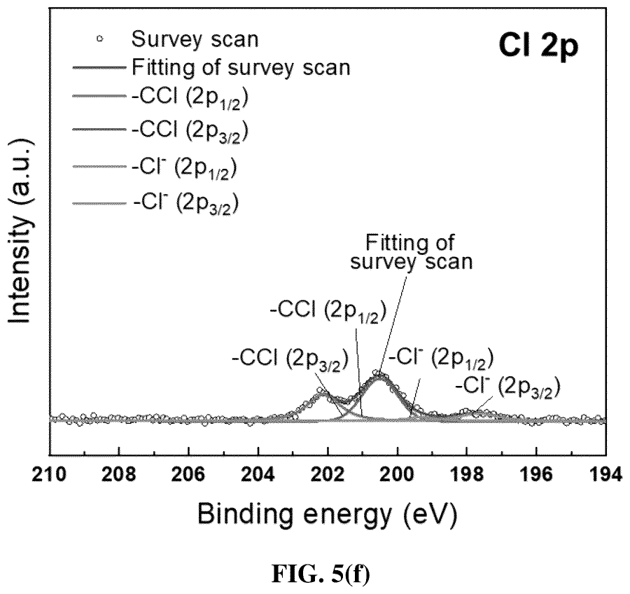

FIG. 5 is a graph showing the spectrum analyzed by core-level X-ray photoelectron spectroscopy (XPS) of N is and Cl 2p to investigate the surface chemical composition in detail.

In FIG. 5, (a) and (d) show the high-resolution spectra of N is and Cl 2p core levels of the cross-linked polyimide hollow fiber (XPI HF) support. It can be confirmed that the cross-linked polyimide support was successfully prepared, as the amide group (—CONH) peak area contributed the most to the total N is peak area.

In FIG. 5, (b) and (g) are the high-resolution spectra of N is and Cl 2p core levels of the carbonyl chloride-functionalized microporous polymer-based ultrathin hollow fiber (PIM-COCl TFC HF) membrane. Herein, after coating the carbonyl chloride-functionalized microporous polymer (PIM-COCl) on the surface of cross-linked polyimide hollow fiber (XPI HF) support, the N is peak intensity decreased, and the main composition was changed to carbonyl amine group (—CONH) and nitrile group (—CN). In addition, it can be confirmed that in view of the appearance of the Cl 2p peak, the carbonyl chloride-functionalized microporous polymer (PIM-COCl) was successfully coated on the support surface.

In FIG. 5, (c) and (h) show the high-resolution spectra of N is and Cl 2p core levels of the cross-linked microporous-based ultrathin hollow fiber (XPIM TFC HF) membrane. Herein, after cross-linking, the peaks of the amide group (—CONH—) and carbonyl amine group (—CONH2) appeared, and it can be confirmed that in view of a decrease in the intensity of Cl 2p peak, intermolecular cross-linking was successful.

In conclusion, it can be confirmed that the carbonyl chloride-functionalized microporous polymer was successfully coated on the cross-linked polyimide hollow fiber support, and cross-linking between the coated carbonyl chloride-functionalized microporous polymer molecules was formed through the cross-linking reaction.

### Experimental Example 3: Analysis of Filtration Performance of a Cross-Linked Microporous-Based Ultrathin Hollow Fiber (XPIM TFC HF) Membrane and Organic Solvent Permeance of a 1.5-Cross-Linked Microporous-Based Ultrathin (XPIM TFC) Membrane

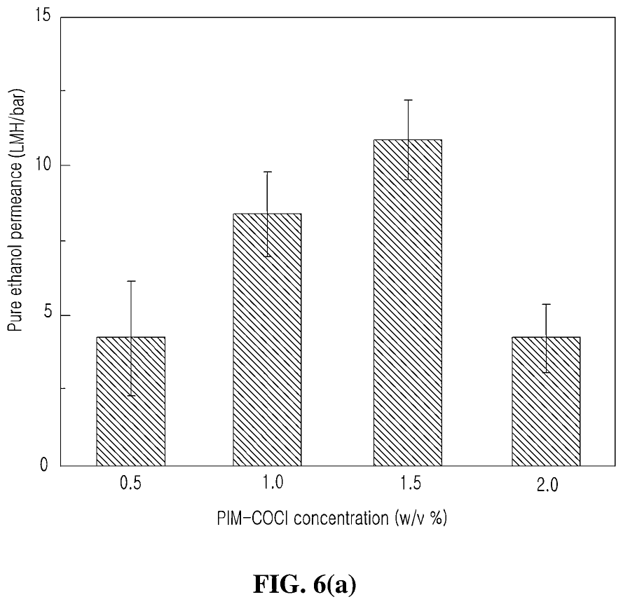

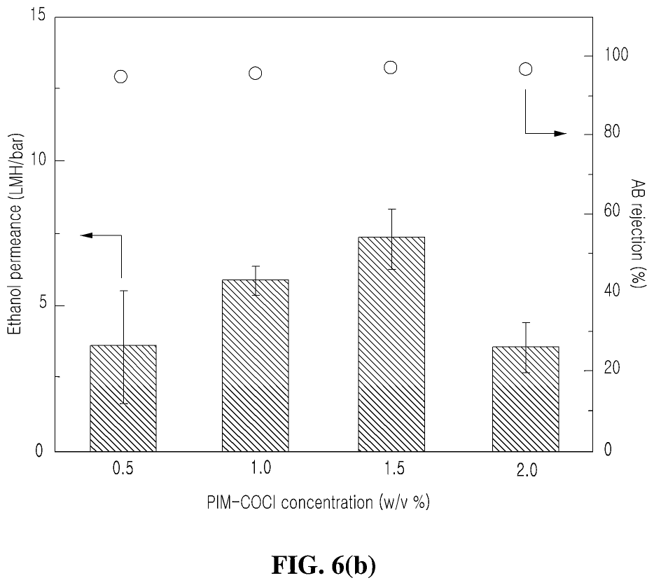

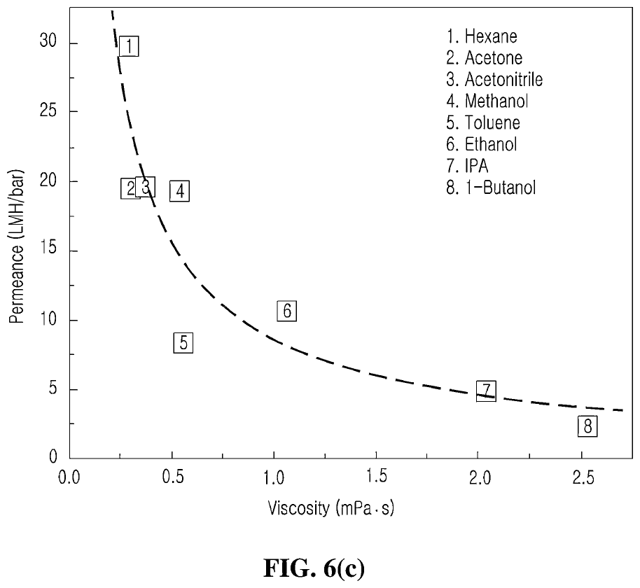

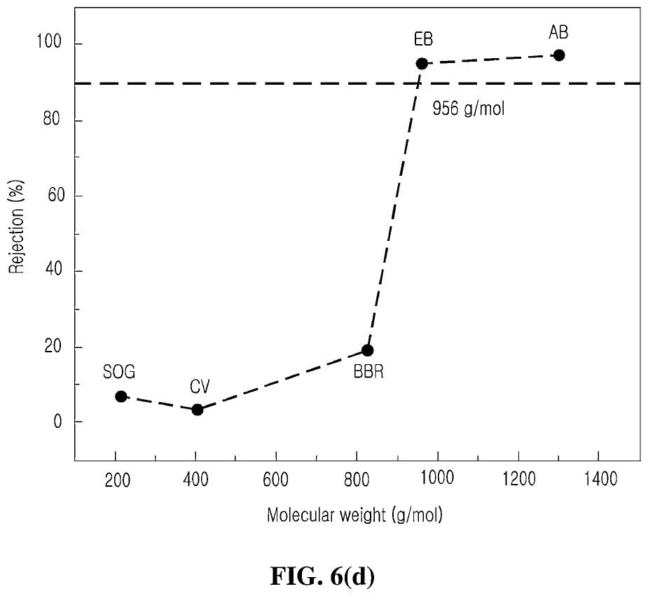

In FIG. 6, (a) and (b) are graphs showing the organic solvent nanofiltration performance of the cross-linked microporous-based ultra-thin hollow fiber (XPIM TFC) membrane.

As the concentration of the carbonyl chloride-functionalized microporous polymer (PIM-COCl) coating solution increased to 1.5 weight/volume %, the pure ethanol permeance increased from 4.2 to 10.9 LMH/bar. However, as the concentration of the carbonyl chloride-functionalized microporous polymer coating solution increased from 1.5 weight/volume % to 2.0 weight/volume %, the thickness of the outer active layer of the cross-linked microporous-based ultrathin hollow fiber membrane increased, and thus, the pure ethanol permeance decreased.

In (c) of FIG. 6, as the results of analyzing the organic solvent permeance of the 1.5-cross-linked microporous-based ultrathin hollow fiber membrane using eight common organic solvents, hexane showed the highest permeance, followed by acetonitrile, acetone, methanol, ethanol, toluene, isopropanol, and 1-butakol in that order. In the case of toluene, it can be confirmed that the permeance appears lower than the trend due to the large ball volume.

In FIG. 6, (d) is a graph analyzing the molecular weight cutoff (MWCO) of the 1.5-cross-linked microporous-based ultrathin membrane.

The molecular weight cutoff refers to the molecular weight of the lowest molecular weight solute at which 90% of the solute is retained by the membrane.

Referring to (d) of FIG. 6, the 1.5-cross-linked microporous-based ultra-thin hollow fiber membrane had low rejection of SOG (Sudan Orange G) 7.1%, CV (Crystal Violet) 3.5%, and BBR (Brilliant Blue R) 19.3%. However, EB (Evans Blue) and AB (Alcian Blue) showed high rejection performance at 94.9% and 97.3%, respectively.

Based on the above rejection performance, the 1.5-cross-linked microporous-based ultrathin hollow fiber membrane had a molecular weight cutoff value of about 952 g/mol in ethanol.

That is, this means that the membrane can remove more than 90% of molecular weights higher than 952 g/mol in ethanol.

Therefore, the cross-linked microporous-based ultrathin hollow fiber membrane showed high ethanol permeance, and the permeance trend of the prepared separation membrane for various organic solvents was inversely correlated with the viscosity of the organic solvent. In addition, it can be confirmed that the prepared separation membrane exhibits the molecular weight cutoff of 952 g/mo in ethanol and exhibits a size-dependent removal mechanism.

### Experimental Example 4: Experiment to Improve Organic Solvent Stability of a Cross-Linked Microporous-Based Ultrathin Hollow Fiber (XPIM TFC HF) Membrane

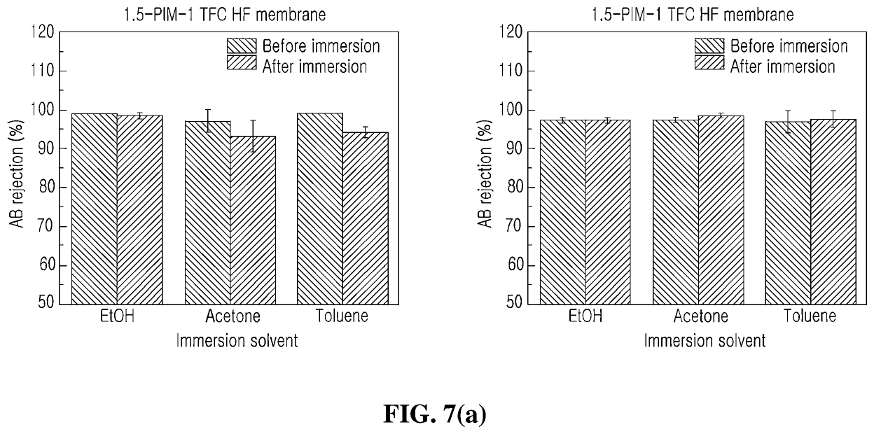

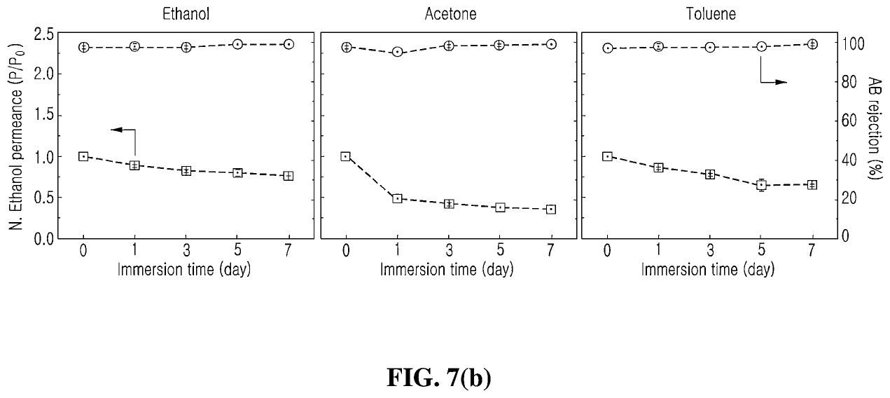

FIG. 7 is a graph analyzing the results of testing the organic solvent stability performance of the cross-linked microporous-based ultrathin hollow fiber (XPIM TFC HF) membrane.

In FIG. 7, (a) shows a change in rejection performance of 1.5-microporous polymer (PIM-1) and 1.5-cross-linked microporous-based ultrathin hollow fiber membrane after immersion in organic solvent for 3 days, and (b) shows the long-term performance of the 1.5-cross-linked microporous-based ultrathin hollow fiber membrane after immersion in organic solvent for 7 days.

In (a) of FIG. 7, the 1.5-microporous polymer-based ultrathin hollow fiber (PIM TFC HF) membrane showed AB rejection performance of more than 95% after immersion in ethanol, but the rejection performance was decreased due to swelling, relaxation, and rearrangement of the polymer chains by acetone and toluene.

On the other hand, it can be confirmed that the 1.5-cross-linked microporous-based ultrathin hollow fiber membrane showed similar rejection performance of more than 95% after being immersed in ethanol, acetone, and toluene for 3 days.

In addition, in (b) of FIG. 7, in order to investigate the long-term performance of the 1.5-cross-linked microporous-based ultrathin hollow fiber membrane, the membrane was tested in the same manner for 7 days. As a result, it can be confirmed that the 1.5-cross-linked microporous-based ultrathin hollow fiber membrane showed stable rejection performance of more than 95% during the test period (7 days) after immersion in ethanol, acetone, and toluene.

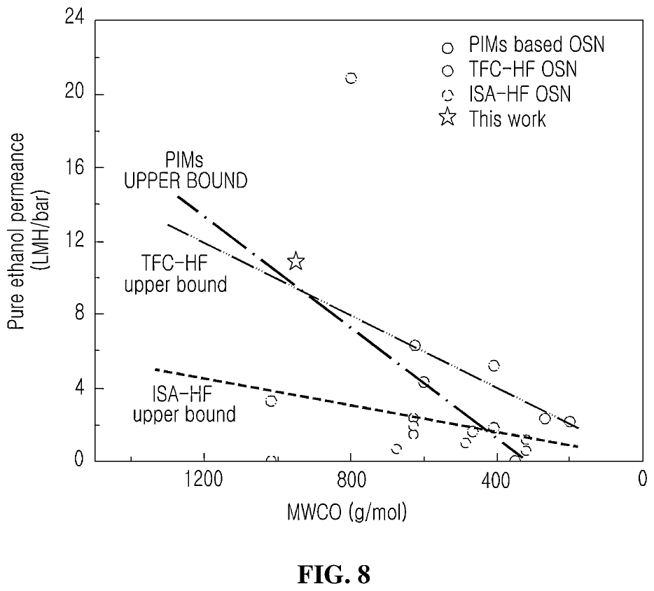

In FIG. 8, as the comparison results of microporous polymer-based organic solvent nanofiltration membrane and hollow fiber organic solvent nanofiltration membrane (both integrally skinned asymmetric ISA and TFC type), in the case of the microporous polymer-based organic solvent nanofiltration membrane, it was confirmed that the pure ethanol permeance ranged from approximately 0 to 21 LMH/bar and the molecular weight cutoff ranged from 200 to 1,000 g/mol, whereas the ultrathin hollow fiber membrane for organic solvent nanofiltration (TFC HF OSN) showed higher permeance than the ISA HF OSN membrane due to its thin selectivity layer.

Therefore, it can be confirmed that the 1.5-cross-linked microporous-based ultrathin hollow fiber (XPIM TFC HF) membrane exhibits equivalent or superior performance to other microporous polymer-based organic solvent nanofiltrations and organic solvent nanofiltration hollow fiber-type membrane in terms of ethanol permeance and molecular weight cutoff.

In conclusion, in order to improve the stability of organic solvents without damaging the pore properties of the microporous polymer (PIMs)-based membrane prepared according to an embodiment of the disclosure, the cross-linked microporous-based ultrathin hollow fiber (XPIM TFC HF) membrane, which introduces intermolecular cross-linking of polymer chains, not only has superior filtration performance compared to existing technologies, but also has improved organic solvent stability, so it is expected to be commercialized as an organic solvent nanofiltration membrane.

The PIMs-based membrane prepared according to the disclosure, which introduces intermolecular cross-linking of polymer chains to improve organic solvent stability without compromising the pore properties of the PIMs-based membrane, not only has excellent filtration performance, but also improves organic solvent stability. Accordingly, it can be commercialized as an organic solvent nanofiltration membrane.

The effects of the disclosure are not limited to the above-mentioned effects, and it should be understood that the effects of the disclosure include all effects that could be inferred from the configuration of the invention described in the detailed description of the invention or the appended claims.

The above-mentioned embodiments of the disclosure are merely examples, and it will be understood by those skilled in the art that various modifications may be made without departing from the technical spirit and scope or essential features of the disclosure. Therefore, it should be understood that the embodiments described above are for purposes of illustration only in all aspects and are not intended to limit the scope of the disclosure. For example, each component described in a single form may be implemented in a distributed form, and similarly, components described in the distributed form may be implemented in a combined form.

The scope of the disclosure is defined by the appended claims, and it should be construed that all modifications or variations derived from the meaning, scope, and equivalent concept of the claims fall within the scope of the disclosure.

What is claimed is:

1. A polymer for a hollow fiber membrane for organic solvent nanofiltration, comprising an intermolecular cross-linked polymer represented by Formula (1) below:
[Formula 1] [symbol]
(where the x is an integer from 2 to 12, the n is an integer from 2 to 7000, and the y is an integer from 2 to 7000).

2. The polymer of claim 1, wherein the intermolecular cross-linked polymer is formed by cross-linking a cross-linking agent between polymers represented by Formula (2) below:
[Formula 2] [symbol]
(where the n is an integer from 2 to 7000).

3. The polymer of claim 2, wherein the cross-linking agent includes an alkyldiamine-based cross-linking agent.

4. The polymer of claim 3, wherein alkyldiamine-based cross-linking agent includes hexadiamine.

5. A method for manufacturing a polymer for a hollow fiber membrane for organic solvent nanofiltration comprising the steps of:
preparing a microporous polymer (PIM-1);
generating a carboxylic acid-functionalized microporous polymer (PIM-COOH) by functionalizing a functional group of the microporous polymer (PIM-1);
producing a carbonyl chloride-functionalized microporous polymer (PIM-COCl) by adding thionyl chloride to the carboxylic acid-functionalized microporous polymer (PIM-COOH); and
preparing an intermolecular cross-linked polymer by adding an alkyldiamine-based cross-linking agent to the carbonyl chloride-functionalized microporous polymer (PIM-COCl).

6. The method of claim 5, wherein the functional group of the microporous polymer (PIM-1) includes methyl, ether, nitrile, carboxyl, amine, carbonyl chloride, amidoxime, tetrazole, or thioamide.

7. The method of claim 5, wherein the step of preparing the intermolecular cross-linked polymer includes the steps of:
coating the carbonyl chloride-functionalized microporous polymer (PIM-COCl) on a support by performing a dip coating process; and
preparing the intermolecular cross-linked polymer by adding the alkyldiamine-based cross-linking agent to the support coated with the carbonyl chloride-functionalized microporous polymer (PIM-COCl).

8. The method of claim 5, wherein the intermolecular cross-linked polymer includes a polymer represented by Formula (1) below:
[Formula 1] [symbol]
(where the x is an integer from 2 to 12, the n is an integer from 2 to 7000, and the y is an integer from 2 to 7000).

9. A hollow fiber membrane for organic solvent nanofiltration comprising the polymer for the hollow fiber membrane for the organic solvent nanofiltration of claim 1.
